(19) United States
(12) Patent Application Publication
(10) Pub. No.: US 2023/0416046 A1
(43) Pub. Date: Dec. 28, 2023

(54) COMPUTER IMPLEMENTED METHOD AND AN APPARATUS ASSOCIATED WITH A PEOPLE TRANSIT SYSTEM ASSOCIATED USER APPLICATION

(71) Applicant: KONE Corporation, Helsinki (FI)

(72) Inventors: Mika BELOV, Helsinki (FI); Mikko PIIRONEN, Helsinki (FI)

(73) Assignee: KONE Corporation, Helsinki (FI)

(21) Appl. No.: 18/367,340

(22) Filed: Sep. 12, 2023

Related U.S. Application Data
(63) Continuation of application No. PCT/FI2021/050202, filed on Mar. 22, 2021.

(51) Int. Cl. B66B 1/34; B66B 5/00; B66B 1/46; B66B 13/14; B66B 3/00

(52) U.S. Cl. CPC B66B 1/3461; B66B 5/0087; B66B 1/468; B66B 13/146; B66B 3/00; B66B 2201/4676; B66B 25/003

(57) ABSTRACT

A computer-implemented method includes executing a people transit system associated user application, the people transit associated user application enabling a use of multiple operation modes; obtaining a trigger event associated with the people transit system; obtaining profile information associated with a user using the people transit system associated user application; and allowing the use of a specific application mode among multiple application modes based on the trigger event and the profile information.

### BACKGROUND

People transit systems, for example, elevator systems are becoming more and more intelligent and various applications can be used in connection with the elevator systems. As an example, in an elevator system that uses destination calls a mobile application may be provided with which a user is able to place a destination call.

In a people transit system, there may be also other situations in which a mobile device executed application could be used for providing some additional functionality. The challenge may be that a user needs to separately install each of these applications to the user's mobile device in order to enable the additional functionality.

### SUMMARY

According to a first aspect, there is provided a computer-implemented method comprising executing a people transit system associated user application, the people transit associated user application enabling a use of multiple operation modes; obtaining a trigger event associated with the people transit system; obtaining profile information associated with a user using the people transit system associated user application; and allowing the use of a specific application mode among the multiple application modes based on the trigger event and the profile information.

In an implementation form of the first aspect, the method further comprises causing transmission of information associated with the trigger event and at least part of the profile information; receiving information selected based on the information associated with the trigger event and at least part of the profile information; and causing display of the information.

In an implementation form of the first aspect, the trigger event comprises identification information associated with the people transit system.

In an implementation form of the first aspect, the trigger event comprises a location associated with the user.

In an implementation form of the first aspect, the method further comprises sending at least one command to a controller to control an entity of the people transit system.

In an implementation form of the first aspect, the at least one command comprises at least one of an empty call, open doors of an elevator, close doors of an elevator, a request for data associated with at least one elevator, and a request for data associated with at least landing floor.

In an implementation form of the first aspect, the operation modes comprise at least one of a fire mode, a guidance mode, a cleaning mode and a maintenance mode.

In an implementation form of the first aspect, the people transit system comprises at least one of an elevator system, an escalator system and an access system.

According to a second aspect, there is provided an apparatus comprising at least one processor and at least one memory including computer program code. The at least one memory and the computer program code are configured to, with the at least one processor, cause the apparatus to at least perform: obtaining a trigger event associated with the people transit system; obtaining profile information associated with a user using the people transit system associated user application; and allowing the use of a specific application mode among the multiple application modes based on the trigger event and the profile information

In an implementation form of the second aspect, the at least one memory and the computer program code are configured to, with the at least one processor, cause the apparatus to at least perform: causing transmission of information associated with the trigger event and at least part of the profile information; receiving information selected based on the information associated with the trigger event and at least part of the profile information; and causing display of the information.

In an implementation form of the second aspect, the trigger event comprises identification information associated with the people transit system.

In an implementation form of the second aspect, the trigger event comprises a location associated with the user.

In an implementation form of the second aspect, the at least one memory and the computer program code are configured to, with the at least one processor, cause the apparatus to at least perform: sending at least one command to a controller to control an entity of the people transit system.

In an implementation form of the second aspect, the at least one command comprises at least one of an empty call, open doors of an elevator, close doors of an elevator, a request for data associated with at least one elevator, and a request for data associated with at least landing floor.

In an implementation form of the second aspect, the operation modes comprise at least one of a fire mode, a guidance mode, a cleaning mode and a maintenance mode.

In an implementation form of the second aspect, the people transit system comprises at least one of an elevator system, an escalator system and an access system.

According to a third aspect, there is provided a computer program comprising instructions which, when the program is executed by the at least one processor of the apparatus of the second aspect, cause to apparatus carry out the method of any the first aspect.

According to a fourth aspect, there is provided a computer-readable medium comprising a computer program comprising instructions which, when the program is executed by the at least one processor of the apparatus of the second aspect, cause to apparatus carry out the method of any the first aspect.

According to a fifth aspect, there is provided a people transit system comprising an apparatus of the second aspect.

In an implementation form of the fifth aspect, the people transit system comprises at least one of an elevator system, an escalator system and an access system.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 illustrates a flow chart of a method for operating the people transit associated user application.

FIG. 2 illustrates a block diagram of an apparatus according to an example embodiment.

FIG. 3A illustrates an example environment for applying the people transit associated user application according an example embodiment.

FIG. 3B illustrates another example environment for applying the people transit associated user application according an example embodiment.

### DETAILED DESCRIPTION

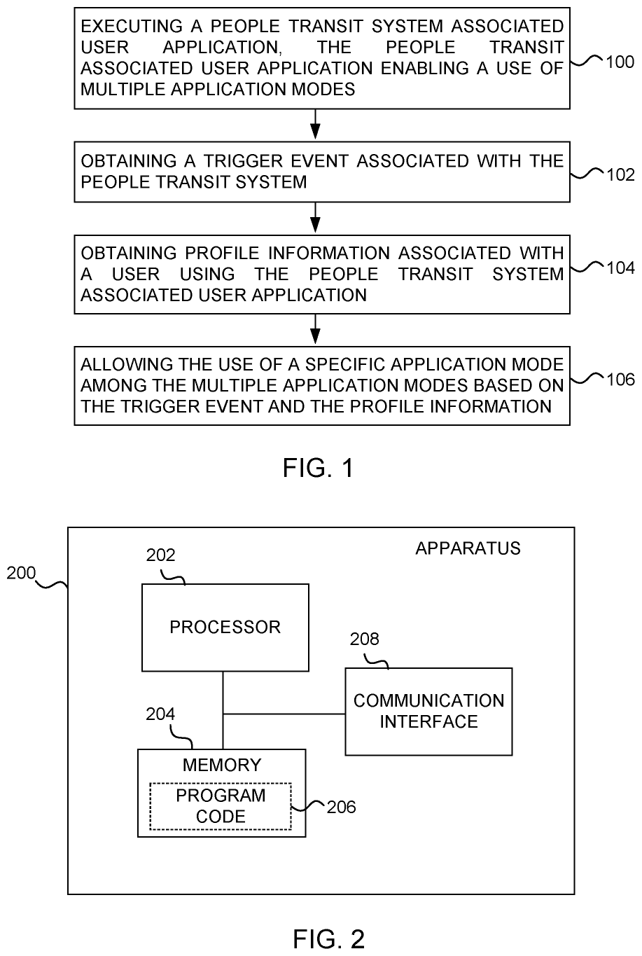

FIG. 1A illustrates a flow chart of a method for operating the people transit associated user application.

At 100 a people transit system associated user application is executed, the people transit associated user application enabling a use of multiple operation modes. The application may be executed, for example, by a mobile device used by a user. In another example embodiment, the application may be provided as a cloud-based service to which the mobile device of the user is connected to. The people transit associated user application may have a plurality of different operation modes based on which it can operate. In an example embodiment, the plurality of operation modes may comprise at least one of a fire mode, a guidance mode, a cleaning mode and a maintenance mode. It is evident that there modes represent only examples and other modes may also be applied. Each operation mode may provide an operation mode specific user interface with the application.

At 102 a trigger event associated with the people transit system may be obtained. In an example embodiment, the trigger event may comprise a user input. The user may input, for example, his/her credentials or some identifier to the application. In another example embodiment, the trigger event may comprise identification information associated with the people transit system. For example, the application may obtain the trigger event from another source, for example, by reading a visual identifier, for example, a QR code or some other machine-readable code. Yet in another example embodiment, the trigger event may be location dependent. For example, the trigger event may be triggered when the user reaches a predetermined location in a building.

At 104, profile information associated with the user using the people transit system associated user application may be obtained. The user may have logged in into the people transit system associated user application with his/her credentials, and the profile information may identify one or more roles for the user, specific usage rights for the user etc.

At 106 the use of a specific application mode among the multiple application modes may be allowed based on the trigger event and the profile information. For example, when the location of the user is known based on the trigger event and user characteristics are known based on the profile information, it is possible to allow the use of the specific application mode and provide user specific information with the people transit system associated user application.

In an example embodiment, the application may be configured to cause transmission of information associated with the trigger event and at least part of the profile information, receive information selected based on the information and at least part of the profile information, and cause display of the information. This means that the information provided to the user may depend on both the trigger event and the profile information, thus making the information both location and user dependent. In an example embodiment, the displayed information may comprise status information relating, for example, to a status of a single elevator system node or a plurality of elevator system nodes or some other entities. As an example, the status information may provide the status of all elevators of the elevator system. An entity may refer, for example, a single device or node, to a plurality of devices or nodes, a system, a component etc.

In another example embodiment, the application may be configured to send at least one command to a controller to control an entity, for example, a node of the people transit system. The command or commands that are available for the specific operation mode may vary between operation modes. For example, when performing maintenance operations, the user may be allowed to open or close doors a specific elevator with the application.

FIG. 2 illustrates a block diagram of an apparatus 200 according to an example embodiment. The apparatus 200 may be, for example, a mobile apparatus used by a user.

The apparatus 200 comprises one or more processors 202, and one or more memories 204 that comprise computer program code. The apparatus 200 may also include an input/output module (not shown in FIG. 2), and/or a communication interface 208. Although the apparatus 200 is depicted to include only one processor 202, the apparatus 200 may include more than one processor. In an example embodiment, the memory 204 is capable of storing instructions, such as an operating system and/or various applications. The memory 204 may store a people transit associated user application that may be executed by the apparatus 200 to implement various features and embodiment discussed herein.

Furthermore, the processor 202 is capable of executing the stored instructions. In an example embodiment, the processor 202 may be embodied as a multi-core processor, a single core processor, or a combination of one or more multi-core processors and one or more single core processors. For example, the processor 202 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the processor 202 may be configured to execute hard-coded functionality. In an example embodiment, the processor 202 is embodied as an executor of software instructions, wherein the instructions may specifically configure the processor 202 to perform the algorithms and/or operations described herein when the instructions are executed.

The memory 204 may be embodied as one or more volatile memory devices, one or more non-volatile memory devices, and/or a combination of one or more volatile memory devices and non-volatile memory devices. For example, the memory 204 may be embodied as semiconductor memories (such as mask ROM, PROM (programmable ROM), EPROM (erasable PROM), flash ROM, RAM (random access memory), etc.).

In an embodiment, the at least one memory 204 may store program instructions 206 that, when executed by the at least one processor 202, cause the apparatus 200 to perform the functionality of the various embodiments discussed herein. Further, in an embodiment, at least one of the processor 202 and the memory 204 may constitute means for implementing the discussed functionality.

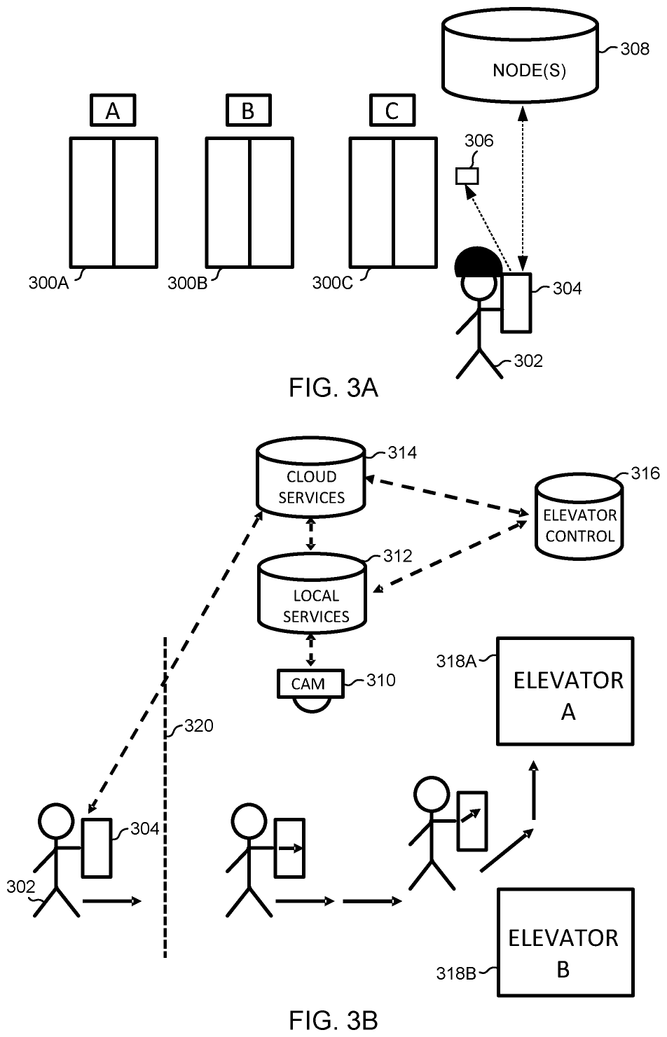

FIG. 3A illustrates an example environment for applying the people transit associated user application according an example embodiment. Although the solution is discussed using an elevator system as an example, the principles of the solution may be applied also in other people transit systems, for example, in an escalator system and an access system. Further, although the example discussed a mobile device based solution, the solution may be implemented also as a cloud-based solution.

A people transit system associated user application executed by a mobile device 304 may obtain an elevator identifier 306, for example, in a form of a QR code. The QR code may be available for scanning close to each elevator 300A, 300B, 300C.

In an example embodiment, the user 302 is using the mobile device 304 as a fireman. A user profile may be associated with the user 302, and the user profile may associate, for example, specific usage rights for the user 302. Based on the trigger event, i.e. the obtained elevator identifier, and the user profile, the fireman may be allowed to use the application in a specific application mode, i.e. in a fireman operation mode. When the QR code or some other identification information associated with the elevator is read, the application may transmit information included in the QR code or some other identification information and at least part of the profile information to an entity, for example, to an elevator system node, and receive information selected based on the transmitted information. The information provided to the application may comprise, for example, fireman display information (for example, current location and direction of one or more elevators).

In an example embodiment, the application may request, for example, floor and/or status information from a node 308, for example, a cloud service node and/or from a node providing site based fireman services. In an example embodiment, when the fireman enters the elevator 300C, the mobile device 304 may provide to the fireman a mobile COP panel and/or a fire information display, which may provide additional information related fire and evacuation services/status.

In another example embodiment of FIG. 3A, the application may operate in a cleaning operation mode. Again, the application executed by the mobile device 304 may obtain the elevator identifier 306, for example, in the form of a QR code. The QR code may be available for scanning close to each elevator 300A, 300B, 300C. The application may transmit the elevator identifier 306 and at least part of the profile information to the node 308, and the application may start operating in the cleaning operation mode. In the cleaning operation mode, the application may be configured to create an empty car call, and the elevator car may be removed from service for cleaning. Further, in an example embodiment, when operating the application in the cleaning operation mode, the user 302 may be able to send a command or commands to an elevator system node, for example, an elevator controller, to open and/or close doors.

In another example embodiment of FIG. 3A, the application may operate in a maintenance operation mode. Again, the application executed by the mobile device 304 may obtain the elevator identifier 306, for example, in a form of a QR code. The QR code may be available for scanning close to each elevator 300A, 300B, 300C. The application may transmit the elevator identifier 306 and at least part of the profile information to the node 308, and the application may start operating in the maintenance operation mode. In the maintenance operation mode, the application may be configured to create an empty car call, and the elevator car may be removed from service for maintenance. In an example embodiment, when operating the application in the cleaning operation mode, the user 302 may be able to send a command or commands to an elevator system node, for example, an elevator controller, to open and/or close doors.

In another example embodiment of FIG. 3A, the profile information associated with the user may determine a skill level or actions what the user is allowed to perform. The profile information may then have an effect on what actions the user may perform with the people transit associated user application. For example, if the profile information states that the user can perform only maintenance actions relating to a specific level, only this actions are allowed for the user by the application. Further, in an example embodiment, access to use the application may be denied if the user's profile information identifies an insufficient skill level.

FIG. 3B illustrates another example environment for applying the people transit associated user application according an example embodiment. The application executed by the mobile device 304 may operate in a guidance operation mode. An activation of the guidance operation mode may be initiated, for example, when the user 302 reaches a predetermined threshold location 320. Based on the location and profile information associated with user, the user may be allowed to use the guidance operation mode. In the guidance operation mode, visual and/or voice guidance information may be provided for visually impaired persons. Further, in the guidance operation mode, the application may establish a connection with a node, for example, a cloud service node to enable provision of the guidance information to the user 302. The cloud service node 314 may be connected to a node 312 providing local services. The node 312 may further be connected to at least one camera 310 providing a live feed or still images about the proximity of elevators 318A, 318B. The nodes 312, 314 may further be connected to an elevator controller 316.

The node 312 may be configured to identify (for example, based on information provided by the camera 310) the user's 302 current location, and based on the location the application operating in the guidance operation mode may be used to provide guidance information to the user to reach an the elevator 318A. In an example embodiment, the user 302 may have already earlier given a destination call with the mobile device 304. When the user then reaches the threshold location 320, the mobile device 302 may be configured to start providing guidance information towards the elevator 318A allocated for the destination call.

At least one of the examples and embodiments disclosed above may enable a solution in which a single people transit system associated user application may be operated in multiple operation modes depending, for example, on the user or the usage situation.

Example embodiments may be implemented in software, hardware, application logic or a combination of software, hardware and application logic. The example embodiments can store information relating to various methods described herein. This information can be stored in one or more memories, such as a hard disk, optical disk, magneto-optical disk, RAM, and the like. One or more databases can store the information used to implement the example embodiments. The databases can be organized using data structures (e.g., records, tables, arrays, fields, graphs, trees, lists, and the like) included in one or more memories or storage devices listed herein. The methods described with respect to the example embodiments can include appropriate data structures for storing data collected and/or generated by the methods of the devices and subsystems of the example embodiments in one or more databases.

The components of the example embodiments may include computer readable medium or memories for holding instructions programmed according to the teachings and for holding data structures, tables, records, and/or other data described herein. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may include a computer-readable storage medium that may be any media or means that can contain or store the instructions for use by or in connection with an instruction execution system, apparatus, or device, such as a computer. A computer readable medium can include any suitable medium that participates in providing instructions to a processor for execution. Such a medium can take many forms, including but not limited to, non-volatile media, volatile media, transmission media, and the like.

While there have been shown and described and pointed out fundamental novel features as applied to preferred embodiments thereof, it will be understood that various omissions and substitutions and changes in the form and details of the devices and methods described may be made by those skilled in the art without departing from the spirit of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or embodiments may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

1. A computer-implemented method, comprising the steps of:
executing a people transit system associated user application, the people transit associated user application enabling a use of multiple operation modes;
obtaining a trigger event associated with the people transit system;
obtaining profile information associated with a user using the people transit system associated user application; and
allowing the use of a specific application mode among multiple application modes based on the trigger event and the profile information.

2. The method according to claim 1, further comprising the steps of:
causing transmission of information associated with the trigger event and at least part of the profile information;
receiving information selected based on the information associated with the trigger event and at least part of the profile information; and
causing display of the information.

3. The method according to claim 1, wherein the trigger event comprises identification information associated with the people transit system.

4. The method according to claim 1, wherein the trigger event comprises a location associated with the user.

5. The method according to claim 1, further comprising the step of:
sending at least one command to a controller to control an entity of the people transit system.

6. The method according to claim 5, wherein the at least one command comprises at least one of an empty call, open doors of an elevator, close doors of an elevator, a request for data associated with at least one elevator, and a request for data associated with at least one landing floor.

7. The method according to claim 1, wherein the operation modes comprise at least one of a fire mode, a guidance mode, a cleaning mode and a maintenance mode.

8. The method according to claim 1, wherein the people transit system comprises at least one of an elevator system, an escalator system and an access system.

9. An apparatus comprising:
at least one processor; and
at least one memory including computer program code;
the at least one memory and the computer program code being configured to, with the at least one processor, cause the apparatus to at least perform:
obtaining a trigger event associated with a people transit system;
obtaining profile information associated with a user using a people transit system associated user application; and
allowing the use of a specific application mode among multiple application modes based on the trigger event and the profile information.

10. The apparatus according to claim 9, the at least one memory and the computer program code being configured to, with the at least one processor, cause the apparatus to at least perform:
causing transmission of information associated with the trigger event and at least part of the profile information;
receiving information selected based on the information associated with the trigger event and at least part of the profile information; and
causing display of the information.

11. The apparatus according to claim 9, wherein the trigger event comprises identification information associated with the people transit system.

12. The apparatus according to claim 9, wherein the trigger event comprises a location associated with the user.

13. The apparatus according to claim 9, wherein the at least one memory and the computer program code being is configured to, with the at least one processor, cause the apparatus to at least perform:
sending at least one command to a controller to control an entity of the people transit system.

14. The apparatus according to claim 13, wherein the at least one command comprises at least one of an empty call, open doors of an elevator, close doors of an elevator, a request for data associated with at least one elevator, and a request for data associated with at least one landing floor.

15. The apparatus according to claim 9, wherein the operation modes comprise at least one of a fire mode, a guidance mode, a cleaning mode and a maintenance mode.

16. The apparatus according to claim 9, wherein the people transit system comprises at least one of an elevator system, an escalator system and an access system.

17. A computer program comprising instructions which, when the computer program is executed by at least one processor of an apparatus comprising the at least one processor and a memory, causes the apparatus to carry out the method of claim 1.

18. A non-transitory computer-readable medium comprising a computer program comprising instructions which, when the computer program is executed by at least one processor of an apparatus comprising the at lease one processor and a memory, causes the apparatus to carry out the method of claim 1.

19. A people transit system comprising the apparatus of claim 9.

20. The people transit system according to claim 19, wherein the people transit system comprises at least one of an elevator system, an escalator system and an access system.
